(19) United States
(12) Patent Application Publication
(10) Pub. No.: US 2007/0174216 A1
(43) Pub. Date: Jul. 26, 2007

(54) MAIL HANDLING MACHINE

(75) Inventors: Dennis T. GILHAM, Essex (GB); Pierre Nguyen, Alfortville (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST Technologies, Bagneux (FR)

(21) Appl. No.: 11/625,505

(22) Filed: Jan. 22, 2007

(30) Foreign Application Priority Data
Jan. 23, 2006 (FR) 0650227

(51) Int. Cl. G06F 17/00

(52) U.S. Cl. 705/410

(57) ABSTRACT

A mail handling machine including a print module for printing a postal imprint on a mail item, said print module being stationary and disposed transversely relative to the direction D of movement of the mail items and parallel to the longitudinal edges of each mail item. Preferably, said print module has a single row of ink ejection nozzles.

### FIELD OF THE INVENTION

The present invention relates exclusively to the field of mail handling and it relates more particularly to a novel method of printing on mail items that makes it possible to implement mail handling machines that offer high printing throughput, high printing quality, and improved compactness.

### PRIOR ART

Numerous constraints exist today when designing postage meters or “franking machines” that offer higher performance, and it is, in particular, difficult to reach high printing throughputs while also preserving good printing quality. Achieving such performance in a machine or meter that is compact is a further difficulty.

### OBJECT AND DEFINITION OF THE INVENTION

The present invention is based on an observation made by the inventors that, in current digital postal imprints, the number of columns printed is always much higher than the number of rows printed. Thus, if it is possible to limit the number of mail item formats that can be franked, it is then possible to improve significantly the franking throughput of postage meters that process the most common of such mail item formats merely by acting on the process of printing the postal imprint.

Based on this observation, the inventors have proposed a novel method of printing making it possible to implement a machine that is more compact and faster by printing the postal imprint along the length of the mail item, such a machine including a print module for printing a postal imprint on a mail item, wherein said print module is stationary and is disposed both transversely relative to the direction D of movement of the mail items and parallel to the longitudinal edges of each mail item.

Thus, with such row-by-row printing along the length of the mail item from a stationary print module, the printing throughput is increased in a ratio that can range from one to seven compared with the throughputs of prior art machines.

Depending on the embodiment, said print module can have a single row of ink ejection nozzles, or as many rows of ink ejection nozzles as it has distinct print zones of the postal imprint to be printed, said different rows being disposed along a common line. In which case, at least one of said rows of ink ejection nozzles can have an ink of a different color.

The mail handling machine including the print module of the invention may conventionally be a postage meter but, less conventionally, it may also be a folder/inserter, and it may further include an RFID tag recording module.

### BRIEF DESCRIPTION OF THE DRAWINGS

The characteristics and advantages of the present invention appear more clearly from the following description given by way of non-limiting indication and with reference to the accompanying drawings, in which:

FIG. 1 shows the position of the postal imprint on various mail item formats;

FIG. 2 shows an embodiment of a postage meter of the invention; and

FIG. 3 shows an embodiment of a folder/inserter of the invention.

### DETAILED DESCRIPTION OF A PREFERRED EMBODIMENT

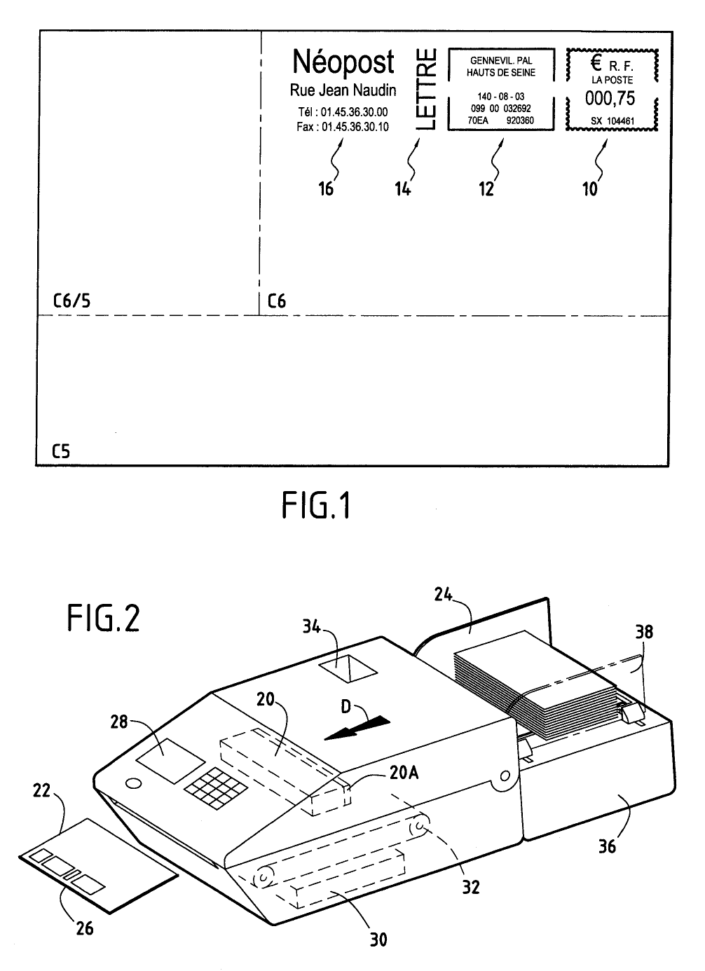

FIG. 1 shows an example of a postal imprint (also referred to as a “franking mark” or “indicia”) as defined by the postal specification of the French postal administration. Similar examples exist with other postal administrations, in particular the US postal administration with its Information Based Indicia Program (IBIP) Standard.

The postal imprint has from two to four distinct zones: a postage stamp zone 10, a date and origin stamp zone 12, a miscellaneous postal information zone 14 and an advertising logo or slogan zone 16, the latter two zones not necessarily being present. All of these indicia lie within a horizontal zone of 160 millimeters (mm) by 25 mm, i.e. in a rectangle that is over six times longer than it is tall, and that is on the top right of the mail item. This positioning of the postal imprint in the top right corner of the mail item is identical regardless of the format of the mail item, and in particular for envelopes of the C6, C6/5 and C5 formats that are the most common formats in Europe, the format C6/5 (114 mm×229 mm) being the standard European format.

In the conventional process of printing on a mail item, the postal imprint is printed dot matrix from a print head, conventionally an ink jet print head, usually having two rows of ink ejection nozzles that are adjacent and offset both transversely and longitudinally, as taught by Patent Application EP 997 852 filed in the name of the Applicant. The two rows of nozzles are disposed transversely relative to the direction D of movement of the mail items, and over the height of the postal imprint, the mail item being moved longitudinally, i.e. it moves parallel to its length (to its longitudinal edges). Each command for ejecting droplets of ink causes a column of the postal imprint to be printed. The franking is complete once all of the columns forming the postal imprint have been printed.

With the present invention, it is proposed to modify the printing process so as to print the postal imprint along its length rather than over its height, so that the printing is performed row-by-row instead of column-by-column.

Printing the postal imprint lengthwise in this manner is obtained, as shown in FIG. 2 which shows an example of a novel postage meter architecture, by disposing preferably a single row of nozzles 20, still transversely relative to the direction D of movement of the mail items, but, above all, parallel to the longitudinal edges of each mail item. In this novel architecture, the mail item moves transversely and is thus aligned or “jogged” via its right side edge 22 against a reference wall 24 of the postage meter rather than via its top longitudinal edge 26 as conventionally.

The postage meter shown is preferably a postage meter making it possible to process pre-sorted envelopes, i.e. envelopes of the same known category of weight. This category of weight and the chosen franking services are input by the operator via a conventional man-machine interface 28. Naturally, a processing module (not shown) including franking accounting means or a “Postal Secure Device” (PSD) and a large-capacity reservoir 30 are incorporated, for example, in the base of the machine. In addition to managing the printing, and as is known, said processing means also synchronize the driving of the conveyor means 32, constituted by rollers or belts, that convey the mail items through the postage meter until they are ejected. Naturally, the mail items continue to be aligned or jogged along one side throughout the conveying by the conveyor means. A receptacle 34 serving to receive labels is also provided on the top portion of the postage meter.

A feed module 36 is mounted on the rear of the postage meter, which module extracts and selects one-by-one the mail items that are to be franked. Said mail items are of predefined maximum length, e.g. 230 mm, corresponding to the dimensions of the inlet and outlet slots of the postage meter so as to ensure that the postage meter is compact. Depending on the available formats, said maximum length can be adjusted merely by means of a presser plate 38. In a more elaborate version of the postage meter, said module can incorporate differential weighing scales that then, in addition to the above-mentioned feed function, perform an additional function of weighing each mail item on the fly, thereby also making it possible for mail items of various weights to be fed in without being pre-sorted by weight. As is known, such scales deliver a weight value that is transmitted to the processing module. Preferably, in this version, in order to avoid slowing down the franking throughput, the postage imprint is printed after the address is printed so as to allow the processing module the time necessary for formulating the imprint (computing the signature or encryption). Light detectors can be provided at the top of the feed module in order to cause the postage meter to stop while it is being loaded and thus in order to avoid any erroneous weight computation.

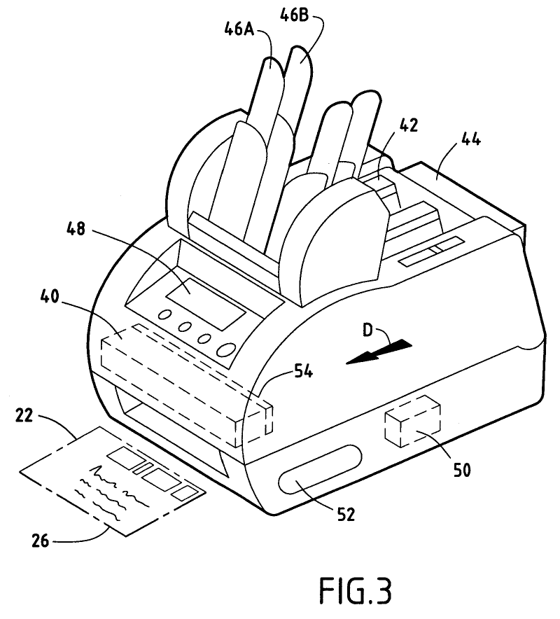

FIG. 3 shows another implementation of the printing method in an architecture based on a folder/inserter by also disposing a row of nozzles 40 transversely relative to the direction D of movement of the mail items and parallel to the longitudinal edges of each mail item, said mail item conventionally, in this type of architecture, being moved transversely with jogging via its side edge. As is known, a folder/inserter includes, associated with a folder and inserter module (not shown), an envelope feed tray 42, a document feed tray 44, and feed trays 46A, 46B for feeding in miscellaneous inserts.

The folder/inserter that is shown is a machine that, since it includes a print module, can also perform franking, i.e. it also has a man-machine interface 48 for enabling the operator to input the various elements necessary for franking, such as a category of weight or the chosen franking service. It can also print the destination address which, as shown in FIG. 3, is printed before the postal imprint is printed in this implementation. Naturally, a processing module 50 including franking accounting means or a “PSD”, and a large-capacity reservoir 52 are incorporated, for example, in the base of the machine. These processing means also manage the printing. A receptacle (not shown) serving to receive labels can be provided on the top portion of the machine.

In accordance with the invention, the print module of the postage meter or of the folder/inserter is of the ink jet type with a print head that can have a single row of ink ejection nozzles disposed, as mentioned above, transversely relative to the path along which the mail items are conveyed and along the length of the postal imprint so as to enable printing to take place over the entire length of the mail item, which moves transversely, the module being stationary. The print head is, for example, a model of the “pagewidth inkjet printhead” type as sold by the Australian company Silverbrook. By its dimensions, such a module also presents the advantage of making it possible to print the destination address or any other information borne by the mail item. It should however be noted that, since the postal imprint is made up of two to four distinct and precisely located zones, it is possible, for the purpose of printing it, to have two to four adjacent rows of nozzles mounted linearly instead of a single row of nozzles, a determined row of nozzles then being assigned to printing a corresponding zone of the postal imprint. This configuration also offers the advantage of making it possible to print in a plurality of colors, the zones 10 and 12 being required to be printed with a postal ink, whereas the zones 14 and 16 can be printed with any ink and thus, for example, with an ink of a different color.

The advantages of such printing along the length of the mail item are particularly significant. Firstly, in terms of speed, because the number of rows printed is much smaller than the number of columns printed, it being possible for the ratio to range from one to seven. Secondly, in terms of printing quality, because printing with a single row of nozzles avoids the problem conventionally posed by aligning the two rows of nozzles in the prior art. Finally, in terms of compactness (and thus transportability), because conveying the mail items widthwise rather than lengthwise makes it possible to shorten the movements in the machine.

It should be noted that this architecture lends itself easily to adding a radiofrequency identification (RFID) tag recording module (references 20a and 54) advantageously disposed alongside the ink jet print module 20, 40 for recording data in RFID tag modules present on the documents inserted into the envelopes franked by the mail handling machine, or on the envelopes themselves.

What is claimed is:

1. A mail handling machine including a print module for printing a postal imprint on a mail item, wherein said print module is stationary and is disposed both transversely relative to the direction D of movement of the mail items and parallel to the longitudinal edges of each mail item.

2. A mail handling machine according to claim 1, wherein said print module has a single row of ink ejection nozzles.

3. A mail handling machine according to claim 1, wherein said print module has as many rows of ink ejection nozzles as it has distinct print zones of the postal imprint to be printed, said different rows being disposed along a common line.

4. A mail handling machine according to claim 3, wherein at least one of said rows of ink ejection nozzles has an ink of a different color.

5. A mail handling machine according to claim 1, further including a folder and insertion module for folding documents and inserting them into envelopes before said envelopes are franked by said print module.

6. A mail handling machine according to claim 1, further including an RFID tag recording module.
